(19) United States
(12) Patent Application Publication
(10) Pub. No.: US 2026/0102922 A1
(43) Pub. Date: Apr. 16, 2026

(54) VENDING MACHINE FOR DISPENSING FOOD

(71) Applicant: Festo SE & Co. KG, Esslingen (DE)

(72) Inventors: Leif PUDEWILLS, Esslingen (DE); Siegfried KEUSCH, Plochingen (DE); Petra KEUSCH, Aidlingen (DE); Hans-Jörg HOPFENGART, Aichwald (DE); Tobias WAIBEL, Ostfildern (DE)

(21) Appl. No.: 19/355,668

(22) Filed: Oct. 10, 2025

(30) Foreign Application Priority Data
Oct. 14, 2024 (DE) 10 2024 129 629.1

(51) Int. Cl. B25J 9/16; B65G 1/04

(52) U.S. Cl. CPC B25J 9/1697; B65G 1/04

(57) ABSTRACT

A food vending machine for dispensing food items, including a machine frame, a product display for storing food items, an image processing system for optically detecting a spatial arrangement of food items, a manipulator for handling food items, and a manipulator control for controlling the manipulator depending on the spatial arrangement of the food items. The manipulator control is coupled to the image processing system and the manipulator includes an intermediate storage for the intermediate storage of a selection of food items provided by the manipulator and for the transport of the selection of food items to a packaging unit or to a goods issue area.

### CROSS-REFERENCE TO RELATED APPLICATION

This application claims priority to German application no. 10 2024 129 629.1 filed Oct. 14, 2024, which is incorporated by reference.

### BACKGROUND

The invention relates to a vending machine for dispensing food. In a food vending machine known from the prior art, different packaged foods, such as beverage cans, energy bars, and sandwiches, are stored in horizontally aligned storage shafts within a machine frame, wherein the machine frame is provided with cover parts to form a closed machine housing. Each of the storage shafts is assigned a conveyor device with which the food stored in the storage shaft can be conveyed horizontally into a dispensing shaft after a customer has requested it. Upon entering the dispensing shaft, the food falls down into a removal area located away from the storage shafts. This removal area is equipped with a pivotable flap to enable the customer to remove the requested food without being able to access the storage shafts. In a further development of such a food vending machine, a vertically movable tray is provided in the dispensing shaft, which can be moved to the level of the storage shaft from which a food item is to be dispensed. After the food has been pushed out of the storage shaft onto the tray, the tray is then moved downwards in a vertical direction to allow the customer to remove the requested food.

### SUMMARY

The purpose of the invention is to provide a food vending machine with which unpackaged food can be dispensed to customers.

This task is solved by the food vending machine having a machine frame to which a product display for storing food, in particular unpackaged food items, an image processing system for optically detecting a spatial arrangement of the food items, a manipulator for handling the food items, and a manipulator control coupled with the image processing system are assigned, wherein the manipulator control controls the manipulator depending on the spatial arrangement of the food items and wherein the manipulator is assigned an intermediate storage for the intermediate storage of a selection of food items provided by the manipulator and for the transport of the selection of food items to a packaging unit or to a goods issue area.

The machine frame comprises an arrangement of profile parts or a combination of profile parts and cladding parts or an arrangement of cladding parts and forms the mechanical framework for the food vending machine. Preferably, the machine frame is provided with cladding parts to form a closed machine housing.

A product display is arranged on the machine frame, which product display is designed for storing food items. Depending on the type of food to be sold using the food vending machine, the product display can be designed as a tray with a flat surface or as a tray with a plurality of recesses, which are preferably arranged in a predetermined grid pattern. Preferably, the product display is arranged in such a way that it is easy for a customer to view the food items displayed there. This can be ensured, for example, by aligning the product display at a slight angle to a horizontal plane so that a customer who wants to view the food items on the product display, for example through a viewing window fixed to the machine frame, can see at least most of the food items placed on the product display.

Furthermore, the food vending machine comprises a manipulator with which individual food items can be placed on the product display or removed from the product display. For this purpose, the manipulator has a gripper with which the respective food item can be gripped by force and/or form. Furthermore, the manipulator enables the food items to be moved spatially in three spatial directions, each aligned perpendicularly to the other in pairs. Preferably, two of the spatially aligned directions of the manipulator span a plane of movement that is aligned parallel to a surface of the product display. The third spatial direction can be aligned parallel to a surface normal on the surface of the product display or, for example, aligned in a vertical direction, also known as the perpendicular direction. The manipulator can, for example, be designed as a multi-axis industrial robot with electric and/or pneumatic and/or hydraulic drives.

In order to enable the manipulator to perform a targeted gripping operation for food items that are placed on the product display, an image processing system is assigned to a manipulator control, which manipulator control controls the respective drives of the manipulator. This image processing system comprises an optical sensor, in particular a camera, for generating image signals. These image signals are evaluated by a microprocessor of the image processing system with the aid of a computer program running on the microprocessor. Information is derived from the image signals, which the manipulator control can use to control the drives of the manipulator. The manipulator control may also be a microprocessor with corresponding electrical and electronic peripherals, on which a computer program runs that is designed to perform targeted control (open loop control) or regulation (closed loop control) of the individual drives of the manipulator. It is advantageous if the manipulator control is designed to maintain an inventory list for the food items placed on the product display, which also can be called a display shelf, in order to always have up-to-date information regarding the presence of food items at specific locations on the product display for subsequent gripping operations using the manipulator. For example, food items placed on the product display are entered into the inventory list, while food items removed from the product display are removed from the inventory list.

The manipulator is assigned an intermediate storage that is designed to temporarily store several food items which were picked up by the manipulator from the product display in sequential order. The intermediate storage is coupled to the manipulator so that movements of the manipulator in at least one predetermined spatial direction, in particular along a vertically aligned spatial direction, directly result in a movement of the intermediate storage in this spatial direction. The intermediate storage can be designed as a tray with a storage surface or as a container with a concave geometry and is dimensioned for the simultaneous intermediate storage of several food items.

Following the arrangement of a selection of food items on or in the intermediate storage, a subsequent step may be provided for making this selection of food items available to a packaging unit. The packaging unit has the task of packaging the selection of food items and making them available to the customer in a goods issue area. Alternatively, in a subsequent step, it may be provided that the selection of food items stored on or in the intermediate storage facility is made available directly at the goods issue area. In particular, it may be provided that the selection of food items is already placed in packaging when it is stored in the intermediate storage, which packaging is then made available to the customer at the goods issue area.

Advantageous further developments of the invention are the subject of the subclaims.

It is advantageous if a product carrier holder is arranged on the machine frame, which is designed to hold a product carrier, and if the image processing system is designed to detect food items arranged on the product carrier. For example, the product carrier holder is provided on a rear side of the food vending machine that faces away from a front side of the food vending machine, the front side of the food vending machine facing the customer. Preferably, the food vending machine is set up in a building, in particular a retail store, in such a way that the rear side of the food vending machine is only accessible to employees and not to customers. The product carrier holder can be designed in particular as a holder for trays, baking trays, or crates, which are the product carriers, which also can be called product carriers. It is assumed here that the food items arranged on or in the respective product carrier are not precisely arranged in relation to each other. Accordingly, the image processing system is designed to detect food items arranged in a disorderly manner on the product carrier and to derive information from this arrangement of the food items. The image processing system provides position information of the respective food items to the manipulator control in order to subsequently enable the targeted gripping of individual food items and the transport of the gripped food items to the product display. It is preferably provided that the product carrier holder is designed in such a way that a product carrier held therein has an identical or at least similar spatial orientation to the product display. For example, it is envisaged that a surface of the product display determines a display plane on which the food items can be placed and picked up again by the manipulator, and that a surface of the product carrier is aligned with this display plane or parallel to the display plane. This measure keeps the number of movements that the manipulator has to perform in order to pick up a food item from the product carrier and place it on the product display to a minimum, thus enabling food items to be transferred quickly from the product carrier to the product display. It is particularly preferred that at least the optical sensor of the image processing system, which may be designed in particular as a camera, is arranged vertically above the product carrier holder in order to enable rapid detection of the (usually unordered) food items arranged on a product carrier newly fixed to the product carrier holder.

If necessary, an information interface is provided on the product carrier holder, which is designed for contact-based information transfer or contactless information transfer between the product carrier and the image processing system and/or the manipulator control. For example, it may be provided that, when a product carrier is placed on the product carrier holder, information about the properties, for example about the average weight of the food items and/or about the maximum pressure load capacity of the food items or other properties of the food items, such as a production date or a maximum shelf life, which are stored in a storage medium on the product carrier, is transmitted via the information interface.

Alternatively, it may be provided that information that can be read directly by the image processing system, for example a barcode or a QR code, is attached to the product carrier in order to be able to provide essential information about the food items on the product display to the manipulator control without having to provide an information interface for this purpose.

It is particularly preferred that the food vending machine comprises a merchandise management control system in addition to the manipulator control or integrated into the manipulator control. This merchandise management control system can thus be integrated either as a separate computer with corresponding software or as a program module in the manipulator control. The merchandise management control system is designed to store information about food items delivered on the product carriers to the food vending machine. This information may include, for example, batch numbers or other parameters related to the delivery and/or manufacture of the food items. In addition or alternatively, the information may relate to how long the respective food item is saleable (best before date) and when, if applicable, a special offer for the respective food items can be issued, for example, if the best before date is about to be reached. Furthermore, merchandise management control can also collect, store, and, if necessary, output information to a higher-level merchandise management system that is geared toward whether a food item is still in the vending machine or has already been packaged and is on its way to the checkout, provided that payment is not intended to be made directly at the vending machine. The merchandise management control system can also be designed to trigger a reorder of food items based on statistical methods if it becomes apparent that the food items stored in the food vending machine are either sold out or will reach its best before date in the foreseeable future. For example, it may be stipulated that the merchandise management control system issues a baking order when more than 50 percent of the baked goods in the food vending machine have been sold.

It is advantageous if the image processing system is designed to recognize the geometric properties of the food items stored on the product carrier, to calculate the gripping coordinates for the respective food items, and to provide the gripping coordinates to the manipulator control. The food items placed on the product carrier and to be transported to the product display by the manipulator are, in particular, natural products, handcrafted products, or industrially manufactured products. Preferably the food items are stored in the food vending machine without an individual packaging. Accordingly, the food items, which may be fruit, vegetables, or baked goods, for example, may have considerable shape tolerances.

In order to ensure that these food items are transported with as little damage as possible, the manipulator must grip the food items with as little gripping force as possible, which is why precise information about the properties of the food items, in particular their size, shape, mass, position and orientation, is required. The task for the image processing system is therefore to first record the spatial arrangement and individual dimensions of the individual food items and then use this information to calculate the gripping coordinates for the manipulator's gripper. The gripping coordinates are determined in particular by the tool center point (TCP) of the gripper and the values required for opening and closing the gripper without damaging the food items and are then passed on to the manipulator control.

When using a symmetrically designed gripper to grasp a food item that is at least essentially spherical in shape, such as an apple, it may be provided that the TCP of the gripper lies on an axis that is aligned normally to the surface of the product carrier for the purpose of performing the gripping operation. In particular, it may be provided that the TCP is located at the center of gravity of the food item. Furthermore, in order to perform the gripping operation, the gripper must first be opened to such an extent that it can approach the food item without mechanical contact between the gripping surfaces of the gripper and the food item. When the food item is subsequently gripped, the gripping surfaces of the gripper are closed in such a way that, on the one hand, the food item is gripped securely and, on the other hand, the pressure exerted on the food item is kept below a specified maximum pressure.

It is preferable that the manipulator control is designed to control the manipulator in such a way that food items are picked up from the product carrier depending on their spatial arrangement and placed on the product display in a specified spatial arrangement, and that food items are picked up from the product display depending on a selection order and made available to the intermediate storage facility. It is assumed here that the food items arranged on the product carrier do not have a predetermined spatial arrangement, for example in a fixed grid. Rather, the food items on the product carrier are arranged in such a disorderly manner that, for each of the food items, the image processing system must first calculate the gripping coordinates, the opening values for the gripper, and the closing values for the gripper. After performing this calculation for individual food items or for all of the food items arranged on the product carrier, the manipulator can pick up the respective food item from the product carrier and transport it to the product display. At the product display, the food items are to be placed by the manipulator in a predetermined spatial arrangement, whereby this placement can be carried out, for example, in a square grid or in another predetermined manner. It is envisaged that the position of each of the food items arranged on the product display will remain stored in the manipulator control until the food item has been transported by the manipulator to the intermediate storage area. If necessary, it may be provided that the manipulator performs a re-sorting of the food items arranged on the display at recurring intervals or at the operator's request in order to ensure an advantageous appearance for the food items displayed there.

In a further development of the invention, it is envisaged that several product displays are arranged on the machine frame, the surfaces of which are spaced apart in a vertical direction and aligned parallel to each other, and that the manipulator is mounted on the machine frame so that it can move linearly along the vertical direction. This enables a high storage density for food items in the vending machine. It is preferable that exactly one type of food item is placed on each of the product displays. Alternatively, different types of food items may be arranged on one or more product displays. The parallel alignment of the product displays ensures that the manipulator does not have to take into account different spatial alignments of the product displays when picking up or placing food items on the respective product display, thus avoiding complex three-dimensional control of the manipulator. It is preferable that the display levels of the product displays form an angle with a vertical direction, also referred to as the plumb direction or vertical direction, which is, for example, within an interval of 65 degrees to 85 degrees. In order to ensure a cost-effective design of the manipulator, it is envisaged that the manipulator's pick-up and set-down movements for the food items are performed along the vertical direction, while the manipulator's transfer movements for the food items are performed essentially parallel to the display levels of the respective product displays. The displacement of the manipulator with the intermediate storage coupled to it along the vertical direction is preferably carried out by an electric, pneumatic, or hydraulic drive. It is particularly preferred that the manipulator with the intermediate storage is mounted on a carriage, which in turn is mounted so as to be linearly movable along a guide rail aligned in the vertical direction, and that the carriage can be moved along the vertical direction by an electric motor with a threaded spindle drive or a toothed belt drive.

In a further embodiment of the invention, the intermediate storage has a storage surface designed to accommodate a transport container, in particular a folding box. In this embodiment of the intermediate storage, it is assumed that the food items picked up by the manipulator from the display are placed directly into a transport container, which may be, for example, a tub or box, whereby the transport container is either closed automatically or by the customer, or the transport container is designed without a lid for open transport of the food items contained therein.

Alternatively, it is envisaged that the intermediate storage is designed as a receiving shaft with a surrounding shaft wall, wherein the shaft wall borders a receiving opening and a delivery opening, wherein the delivery opening is assigned a closure mounted movably on the shaft wall in order to selectively open or close the delivery opening, and wherein the receiving opening is arranged vertically above the delivery opening. The use of the receiving shaft as an intermediate storage facility can be provided for in cases where the food items displayed on the product display are not particularly sensitive to mechanical handling, as can be assumed, for example, for small baked goods, in particular bake rolls. In this case, it is provided that the food items picked up by the manipulator from the product display are first collected in the receiving shaft. The delivery opening is then released by a relative movement of the closure mounted on the shaft wall from a closed position to an open position. The food items then fall into a transport container arranged vertically below the intermediate storage, in particular a folding carton or a bag. For example, it may be provided that the closure is moved from the closed position to the open position when the manipulator with the intermediate storage attached to it is moved longitudinally in the vertical direction into an unloading position, thereby causing a forced swivel movement of the closure about a swivel axis. As soon as the manipulator with the intermediate storage moves upward in the vertical direction from the unloading position, a spring device causes an automated closing process for the closure, so that a new selection of food items can be picked up in the receiving shaft.

In an advantageous further development of the invention, a packaging unit is provided on the machine frame, which is designed to supply packaging from a packaging storage unit, to open the packaging, and to close the packaging after receiving the selection of food items temporarily stored in the intermediate storage. For example, the packaging unit is designed to remove a paper bag from a packaging storage unit, to open the paper bag in such a way that the bag opening is located below the intermediate storage, and to close the bag after the selection of food items has been picked up from the receiving shaft.

It is preferred that the manipulator has several arm sections, each of which is connected to the others by joints, and that a working area of the manipulator encompasses the product display and the product carrier. It is particularly preferred that the manipulator is designed in the manner of a horizontal articulated arm robot (SCARA robot), whereby, in deviation from the typical configuration of such a horizontal articulated arm robot, the linear axis is assigned to the first arm section. For example, it is envisaged that the linear axis is formed by a carriage which is mounted on a profile rail so as to be linearly movable in the vertical direction. It may be provided that a swivel joint with an associated drivee is formed between the carriage and the first arm section, between the first arm section and the second arm section, and between the second arm section and the third arm section. The gripper is arranged on the third arm section and, for the purpose of performing the gripping movement, preferably has a linear degree of freedom of movement for at least one of at least two gripping jaws arranged opposite each other, wherein a drive for the movement of the at least one gripping jaw can be accommodated in the third arm section.

In a further embodiment of the invention, the product displays are arranged adjacent to a movement space for the manipulator, in which movement space the manipulator can be moved in the vertical direction with a compact arrangement of the arm sections. For example, the movement space extends with a rectangular profile along the vertical axis and is bounded on both sides by product displays. This allows efficient use of the maximum movement range of the manipulator, which can place food items on product displays arranged to the right and left of the movement space or pick it up from there by means of swivel movements of its arm sections. In a compact arrangement of the manipulator, it is assumed that the longitudinal axes of the first arm section and the second arm section are aligned parallel to each other, so that a projection of the manipulator onto a horizontal plane aligned transversely to the vertical direction has a minimum area.

### BRIEF DESCRIPTION OF THE DRAWINGS

An advantageous embodiment of the invention is shown in the drawing. Here,

FIG. 1 shows a purely schematic perspective view of a food vending machine,

FIG. 2 shows a purely schematic side view of the food vending machine according to FIG. 1, and

FIG. 3 shows a schematic section from FIG. 1 to illustrate the functioning of the manipulator.

### DETAILED DESCRIPTION

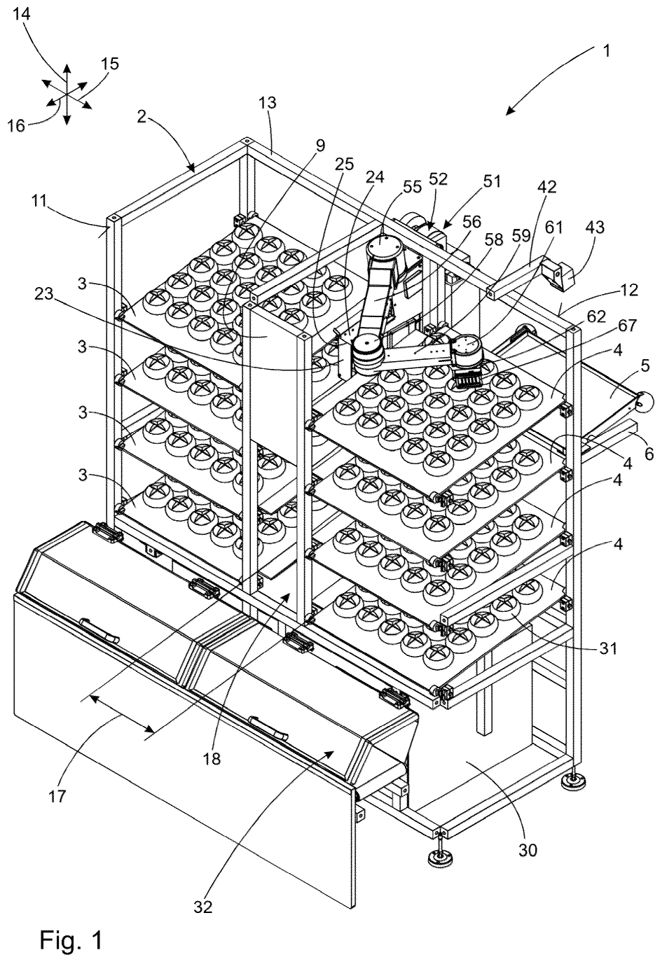

A food vending machine 1, shown purely schematically in FIGS. 1 to 3, is intended, for example, for the sale of baked goods 31, which are shown as bread rolls for the sake of simplicity.

The food vending machine 1 can be used, for example, in a supermarket, in which case it is provided with a cover (not shown) to prevent customers from directly accessing the baked goods 31 and thus also to prevent customers from coming into contact with a manipulator 51, which is provided for the automated handling of the baked goods. The food vending machine 1 is preferably arranged between other food vending machines or shelves (not shown) adjacent to it on either side, so that only the front 11 of the food vending machine 1 is accessible to customers, while the rear 12 of the food vending machine 1 is only accessible from an operator area that only supermarket employees can enter. For example, one or more ovens (not shown) may be provided in this operator area, in which, in particular, pre-made, frozen dough pieces are baked and then made available for sale at the food vending machine 1 in the manner described in more detail below.

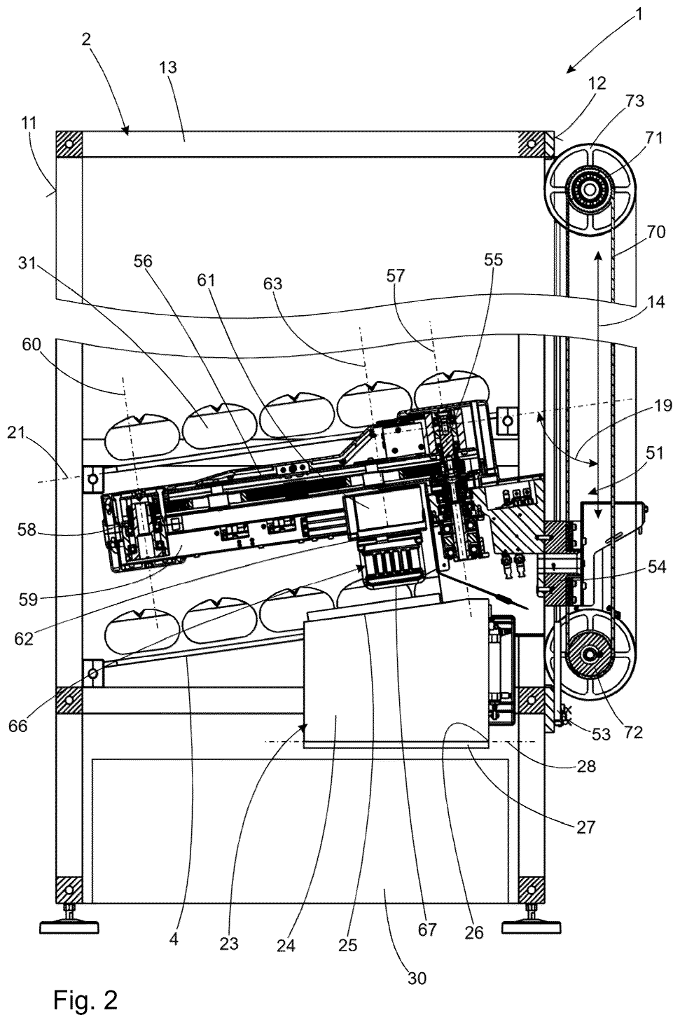

Purely by way of example, the food vending machine 1 comprises a machine frame 2 formed from a plurality of horizontally and vertically aligned profile rails 13, which are connected to each other by suitable connecting elements. For example, two groups of product displays 3, 4 are arranged on the machine frame, each of which is designed as a plane parallel plate with a square base area. The product displays 3 of the first group are each aligned parallel to each other and are each spaced at the same distance in a vertical direction 14. The product displays 4 of the second group are each aligned parallel to each other and are each spaced at the same distance in the vertical direction 14. For example, it is envisaged that adjacent product displays 3, 4 are each arranged in a common display plane 21, which is shown schematically in FIG. 2.

The product displays 3, 4 are arranged in a first horizontal direction 15 with a distance 17 between them, whereby a space for movement 18 is kept free between the product displays 3, 4, which has a rectangular cross-section in a cross-sectional plane not shown, aligned transversely to the vertical direction 14.

Furthermore, it is provided that the product displays 3, 4 form an angle 19 with the vertical direction 14, which is 85 degrees purely by way of example. This ensures that a customer (not shown) viewing the product displays 3, 4 obtains the best possible overview of all the baked goods placed on the product displays 3, 4.

For example, it is provided that the movement space 18 at the front 11 of the food vending machine 1 is limited, at least in some areas, by a display 9, which is shown only schematically, and which may be, for example, a touch-sensitive screen (touchscreen). This display 9 serves to visualize user information and, if necessary, to enter purchase requests, which are implemented by the food vending machine 1 in the manner described in more detail below.

In the area of the rear side 12 of the food vending machine 1, a guide rail 53 extends parallel to the vertically aligned profile rails 13, which guide rail 53 is provided for linear guidance of a carriage 54 along the vertical direction 14 and which is connected to the profile rails 13 of the machine frame 2 in a manner not shown in detail.

The carriage 54 carries a first swivel drive 55, which comprises an electric motor, not shown in detail, and a swivel joint, also not shown in detail, wherein the swivel joint is designed for the swivel-movable mounting of a first arm section 56 relative to the carriage 54. The first swivel drive 55 allows the first arm section 56 to be pivoted relative to the carriage 54 about a first pivot axis 57. A second swivel drive is attached to an end region of the first arm section 56 facing away from the first swivel drive 55, which comprises an electric motor (not shown in detail) and a swivel joint (not shown in detail), wherein the swivel joint is designed for swivel-mounted support of a second arm section 59 relative to the first arm section 56. The second arm section 59 can be pivoted about a second pivot axis 60 relative to the first arm section 56 by means of the second pivot drive 58. A third swivel drive 61 is arranged at an end region of the second arm section 59 facing away from the second swivel drive 58, which comprises an electric motor (not shown in detail) and a swivel joint (not shown in detail), wherein the swivel joint is designed for a pivotable mounting of a third arm section 62 relative to the second arm section 59. With the third swivel drive 61, the third arm section 62 can be pivoted relative to the second arm section 49 about a third pivot axis 63. As can be seen from the illustration in FIG. 2, the first pivot axis 57, the second pivot axis 60, and the third pivot axis 63 are aligned parallel to each other and perpendicular to the display plane 21.

The third arm section 63 carries a gripper 66, which is designed purely as an example as a two-jaw gripper and in which the opposing gripping jaws 67, of which only one is visible in each of the illustrations in FIGS. 1 to 3, can be moved linearly toward or away from each other by a drive integrated in the third arm section 62 and not shown in detail, in order to enable a gripping movement or release movement of these gripping jaws 67.

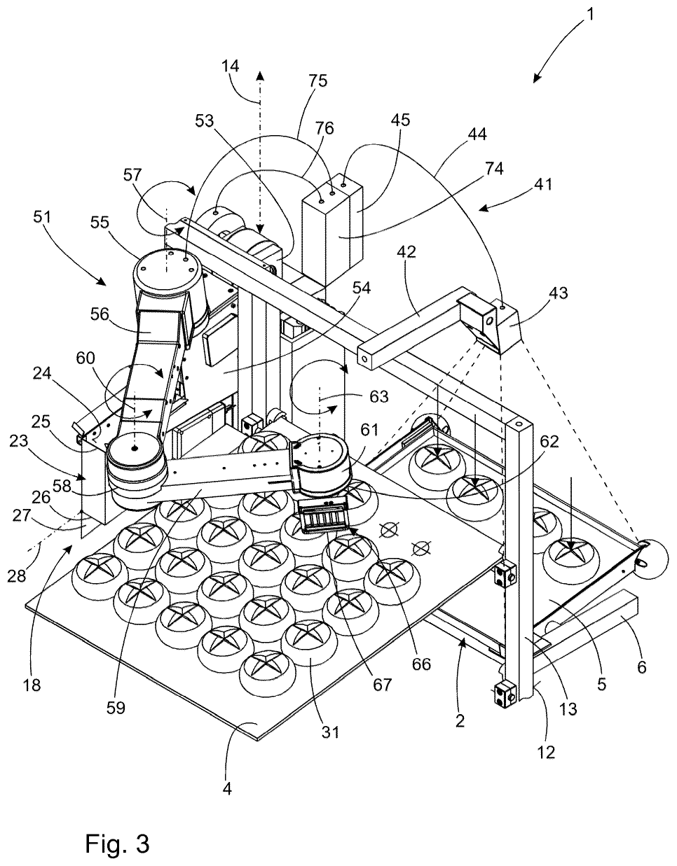

In addition to the first swivel drive 55, an intermediate storage 23 is arranged on the carriage 54, which is designed, purely as an example, in a box shape with a vertically aligned shaft wall 24 that delimits a receiving opening 25 and a discharge opening 26. The receiving opening 25 is always open and thus allows food items, for example baked goods 31, to be fed into the intermediate storage 23. The discharge opening 26 is closed by a plate-shaped closure 27, as shown in FIG. 2, so that baked goods 31 received in the intermediate storage 23 do not fall out downwards. As shown in FIG. 3, the closure 27 pivots about a pivot axis 28, thereby opening the discharge opening 26 and allowing the baked goods 31 to be discharged downwards from the intermediate storage 23.

For example, a packaging unit 30, shown only schematically, is provided below the intermediate storage 23, which can be configured, for example, to packaging the baked goods 31 discharged from the intermediate storage 23 into a transport container such as a bag or box and providing this transport container at the front 11 of the food vending machine 1 to a dispensing interface 32 shown schematically in FIG. 1, which can be opened by a customer in order to remove the transport container contained therein.

For linear movement of the carriage 54 along the guide rail 53, the carriage 54 is fixed to a toothed belt 70, which is partially wrapped around a first pulley 71 and a second pulley 72, wherein the first pulley 71 is arranged in the vertical direction 14 above the second pulley 72. A drive motor 73 is assigned to the first pulley 72, which is designed, for example, as an electric motor and can initiate a rotational movement on the second pulley 72 in order to effect a linear movement of the carriage 54 in the vertical direction 14.

The manipulator 51 comprises the sections 56, 59, 62 with the associated swivel drives 55, 58, 61, the guide rail 53, the carriage 54, the toothed belt 70 with the pulleys 71 and 72, and the drive motor 73. The manipulator 51 can be used to pick up and place food items on the product displays 3, 4.

Furthermore, the manipulator 51 is designed to pick up food items from a product carrier 5, which can be attached to a product carrier holder 6 on the rear side 12 of the food vending machine 1. For example, the product carrier 5 is designed as a baking tray, and a large number of baked goods 31 are arranged in a disorderly manner on the product carrier 5. As can be seen from the illustrations in FIGS. 1 and 3, the product carrier 5 is aligned parallel to the display plane 21 of the product displays 3, 4, thereby ensuring efficient gripping and depositing of baked goods 31 by the gripper 66.

To enable this targeted gripping of the baked goods 31 by the gripper 66, a camera 43 is arranged on the machine frame 2, which is designed for optical detection of the entire surface of the product carrier 5, as shown by the dashed symbol in FIG. 3. For this purpose, the camera 43 is attached to a camera carrier 42, which in turn is fixed to one of the profile rails 13. The camera 43 is connected via an electrical connection line 44 to a microcomputer 45, which is shown in a highly schematic manner, wherein the microcomputer 45 contains a microprocessor, which is not shown in detail, which is designed to use a computer program to process and evaluate the image signals from the camera 43. In the course of evaluating the image signals from the camera 43, the microcomputer 45 determines the size and/or shape and/or orientation of the baked goods 31 and, based on this information, determines the gripping coordinates for the gripper 66 with which the gripper 66 can grasp the respective baked goods 31. These gripping coordinates are symbolized in FIG. 3 by arrows above the respective baked goods 31 lying on the product carrier 5. In addition, it may be provided that the microcomputer 45 also determines a minimum opening value and a maximum closing value for the gripper 66 from the image signals of the camera 43 in order to enable the respective baked goods 31 to be picked up and set down without damage. The camera 43 together with the microcomputer 45 forms an image processing system 41.

The microcomputer 45 is electrically connected via an internal interface (not shown) to a manipulator control 74, which is also shown only schematically

The manipulator control 74 comprises a microprocessor, which is not shown in detail, on which a computer program runs that is configured to control the manipulator 51 on the basis of the information provided by the microcomputer 45. For this purpose, the manipulator control 74 is connected to the manipulator 51 via electrical connection lines 75, 76.

A mode of operation for the food vending machine 1 can be described as follows:

First, an operator (not shown) attaches a product carrier 5 loaded with randomly arranged baked goods 31 to the product carrier holder 6. Next, the baked goods 31 arranged on the product carrier 5 are detected by the camera 43, and the electrical signals from the camera 43 are provided to the microcomputer 45. The microcomputer 45 recognizes the shape, size, and spatial arrangement of the baked goods 31 and uses this information to calculate the gripping coordinates for the gripper 66 as well as the opening and closing values for the gripper 66. This information is transmitted by the microcomputer 45 to the manipulator control 74, which converts this information into movement commands for the individual drives (swivel drive 55, 58, 61 and drive motor 73) of the manipulator 51 and provides these movement commands to the drives of the manipulator 51.

Thus, in subsequent steps, the baked goods 31 arranged on the product carrier 5 are placed by means of the manipulator 51 on the product displays 3, 4 in a predetermined arrangement, in particular a grid arrangement. This grid arrangement is symbolized by the crosshairs shown in FIG. 3 on the product display 4.

As soon as a customer transmits an order for baked goods 31 to the food vending machine 1, which can be done either by direct input on the display 9 or, for example, by using a mobile phone with software configured for the food vending machine 1, the manipulator control 74 decides which movement of the manipulator 51 will pick up the desired baked goods 31 from the product displays 3, 4. If it is necessary to move the manipulator 51 between different levels of the product displays 3, 4, the manipulator 51 is moved into a compact operating position in which the first arm section 56 and the second arm section 59 are aligned parallel to each other and can be moved in the vertical direction 14 within the movement space 18 without colliding.

As soon as a baked good 31 has been gripped with the gripper 66, it is positioned by placing the gripper 66 above the pick-up opening 25 of the intermediate storage 23. As soon as the gripper 66 is opened, the baked good 31 is placed in the intermediate storage 23. As soon as either the desired selection of baked goods 31 has been placed in the intermediate storage 23 or the intermediate storage 23 has reached a predetermined capacity, the manipulator 51 is moved to a transfer position, as shown schematically in FIG. 2. In this transfer position, a minimum distance between the delivery opening 26 of the intermediate storage 23 and the packaging unit 30 is ensured, so that in a subsequent step, by pivoting the closure 27 about the pivot axis 28, the baked goods 31 stored in the intermediate storage 23 are transferred into the packaging unit 30 solely by gravity. In the packaging unit 30, the baked goods are placed in a transport container, such as a bag or box, and preferably a closure of the transport container is carried out. The transport container can then be made available to the customer at the output interface 32.

1. A food vending machine for dispensing food items, comprising a machine frame, a product display for storing food items, an image processing system for optically detecting a spatial arrangement of food items, a manipulator for handling food items and a manipulator control for controlling the manipulator depending on the spatial arrangement of the food items, wherein the manipulator control is coupled to the image processing system and wherein the manipulator comprises an intermediate storage for the storing a selection of food items provided by the manipulator and for transporting the selection of food items to a packaging unit or to a goods issue area.

2. The food vending machine according to claim 1, wherein the machine frame comprises a product carrier holder for receiving a product carrier.

3. The food vending machine according to claim 2, wherein the image processing system comprises an optical sensor and a microprocessor, which is coupled with the optical sensor, wherein the microprocessor comprises a computer program for recognizing geometric properties of the food items placed on the product carrier and for calculating gripping coordinates for the respective food item and for providing the gripping coordinates to the manipulator control.

4. The food vending machine according to claim 2, wherein the manipulator control comprises a microprocessor and wherein the microprocessor comprises a computer program for controlling the manipulator in such a way that food items are picked up from the product carrier depending on their spatial arrangement and placed in a predetermined spatial arrangement on the product display and in such way that the food item is picked up from the product display depending on a customer order and is provided to the intermediate storage.

5. The food vending machine according to claim 1, wherein several product displays are arranged on the machine frame, the surfaces of which are spaced apart in a vertical direction and aligned parallel to each other, and that the manipulator is mounted on the machine frame to be linearly movable along the vertical direction.

6. The food vending machine according to claim 1, wherein the intermediate storage has a storage surface to accommodate a transport container.

7. The food vending machine according to claim 1, wherein the intermediate storage is a receiving shaft with a surrounding shaft wall, wherein the shaft wall defines a receiving opening and a dispensing opening, wherein the dispensing opening is assigned a closure mounted movably on the shaft wall in order to selectively open or close the dispensing opening, and wherein the receiving opening is arranged vertically above the dispensing opening.

8. The food vending machine according to claim 7, wherein a packaging unit is arranged on the machine frame for providing packaging from a packaging storage.

9. The food vending machine according to claim 1, wherein the manipulator has several arm sections, which are each connected to each other by joints, and that a working area of the manipulator covers the product display and the product carrier.

10. The food vending machine according to claim 9, wherein the product displays are each arranged adjacent to a movement space for the manipulator, in which the manipulator can be moved in the vertical direction with a compact arrangement of the arm sections.
